(19) United States
(12) Patent Application Publication
(10) Pub. No.: US 2024/0185057 A1
(43) Pub. Date: Jun. 6, 2024

(54) HYBRID ANALOG SYSTEM FOR TRANSFER LEARNING

(71) Applicant: International Business Machines Corporation, Armonk, NY (US)

(72) Inventors: Takashi Ando, Eastchester, NY (US); Martin Michael Frank, Dobbs Ferry, NY (US); Timothy Mathew Philip, Albany, NY (US); Vijay Narayanan, New York, NY (US)

(21) Appl. No.: 18/074,567

(22) Filed: Dec. 5, 2022

(51) Int. Cl. G06N 3/08; G06F 3/06; G06N 3/065

(52) U.S. Cl. CPC G06N 3/08; G06F 3/0625; G06F 3/0638; G06F 3/0679; G06N 3/065

(57) ABSTRACT

Systems, methods, and semiconductor devices for transfer learning are described. A semiconductor device can include a first non-volatile memory (NVM) and a second NVM. The first NVM can be configured to store weights of a first set of layers of a machine learning model. The weights of the first set of layers can be fixed. The second NVM can be configured to store weights of a second set of layers of the machine learning model. The weights of the second set of layers can be adjustable.

### BACKGROUND

The present application relates to machine learning systems, and in particular to a hybrid analog system that can implement transfer learning.

Transfer learning is a machine learning technique where a machine learning model developed for a source task is retrained or further trained using new dataset for developing a target machine learning model for a target task. A source domain of the machine learning model, the source task, the target domain for the target machine learning model, and the target task can be given. Using transfer learning to train the target learning model, with given source domain and source task, can improve a predictive function of the target machine learning model to perform the target task. Using deep learning as an example, pre-trained models for a source task can be used as the starting point to develop different neural network models for different target tasks.

### SUMMARY

In one embodiment, a semiconductor device for transfer learning is generally described. The semiconductor device can include a first non-volatile memory (NVM) configured to store weights of a first set of layers of a machine learning model. The weights of the first set of layers can be fixed. The semiconductor device can further include a second NVM configured to store weights of a second set of layers of the machine learning model. The weights of the second set of layers can be adjustable.

Advantageously, the semiconductor device in an aspect can improve energy efficiency and memory capacity for transfer learning.

In one embodiment, a method for transfer learning is generally described. The method can include mapping a first set of layers of a machine learning model to a first non-volatile memory (NVM). The method can further include mapping a second set of layers of the machine learning model to a second NVM. The method can further include training the machine learning model by adjusting weights of the second set of layers mapped to the second NVM.

Advantageously, the method in an aspect can improve energy efficiency for transfer learning.

In one embodiment, a device for transfer learning is generally described. The device can include a sensor configured to obtain raw sensor data. The device can further include a chip including a first non-volatile memory (NVM) and a second NVM. The device can further include a processor configured to convert the raw sensor data into a dataset. The processor can be further configured to input the dataset to the NVM, wherein a first set of layers of a machine learning model is mapped to the first NVM. The processor can be further configured to apply the dataset on the first set of layers mapped to the first NVM to generate intermediate data. The processor can be further configured to apply the intermediate data on a second set of layers mapped to the second NVM to generate an output. The processor can be further configured to adjust, based on the output, weights of the second set of layers mapped to the second NVM to train the machine learning model.

Advantageously, the device in an aspect can improve energy efficiency and memory capacity for transfer learning.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example system that can implement hybrid analog system for transfer learning in one embodiment.

FIG. 2 illustrates another example system that can implement hybrid analog system for transfer learning in one embodiment.

FIG. 3A illustrates details of a first analog component of a hybrid analog system for transfer learning in one embodiment.

FIG. 3B illustrates details of a second analog component of a hybrid analog system for transfer learning in one embodiment.

FIG. 4 illustrates an example semiconductor package that can implement hybrid analog system for transfer learning in one embodiment.

FIG. 5 illustrates a flow diagram relating to hybrid analog system for transfer learning in one embodiment.

### DETAILED DESCRIPTION

Transfer learning can be implemented in edge devices. Edge devices can be, for example, resource-constrained, typically small and battery-powered, devices with infrequent, or no connectivity to any cloud computing platform, servers, or datacenters. Some examples of edge devices can include, but are not limited to, drones, swarm systems, Internet of things (IoT) sensors (e.g., industrial, environmental, health monitoring device, or other IoT devices). Edge devices can implement transfer learning to adapt to local or changed conditions (e.g., learning off-the-grid) and thus provide the edge devices with some degree of autonomy. Some challenges of implementing transfer learning in edge devices can include, for example, aspects affecting or related to security and autonomy.

To implement transfer learning, relatively large capacity memory may be needed and there are challenges in maintaining precision of weights. The amount of energy required to implement transfer learning (e.g., to read weights) can be relatively high. While models stored on and/or operating from a cloud computing platform should be re-trained, using the cloud computing platform can present challenges in applications where connectivity is unavailable (e.g., edge devices with limited or no connectivity). Some edge devices can use analog in-memory computing to implement transfer learning, but there are challenges in meeting system requirements for throughput, latency, power, accuracy, reliability, and memory capacity. In general, stochasticity, noise, weight update efficiency, read energy consumption, density (e.g., weights per area) are challenges faced by various implementations of transfer learning in edge devices.

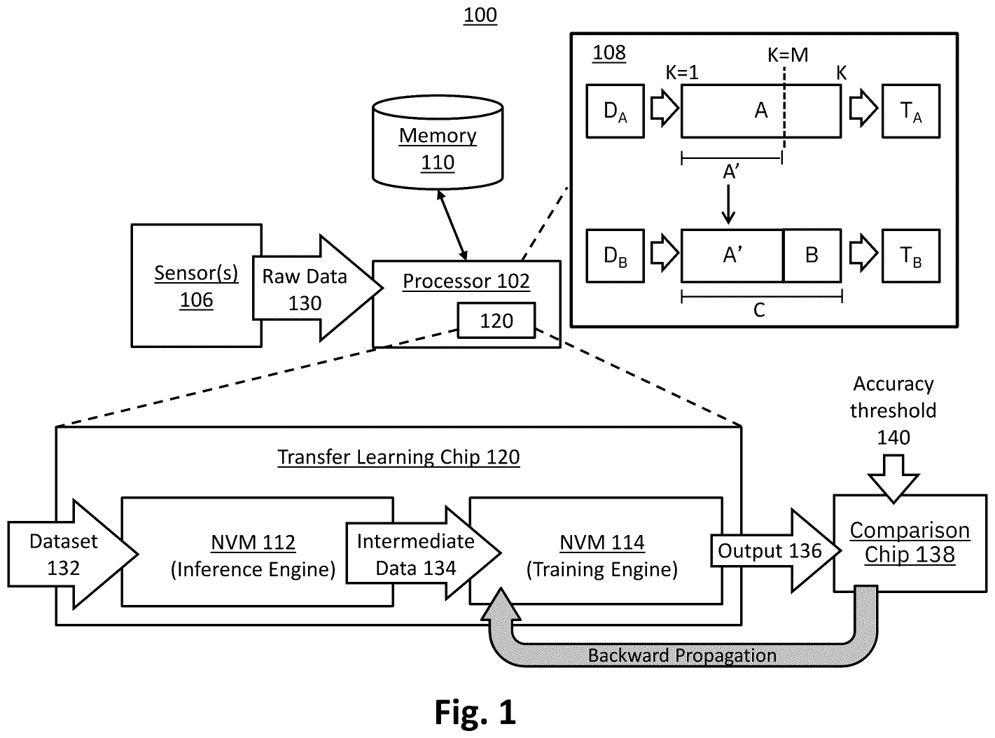

FIG. 1 illustrates an example system that can implement hybrid analog system for transfer learning in one embodiment. A system 100 can be a computing system implemented in a computing device. In one embodiment, system 100 can be implemented in an edge device. System 100 can include a processor 102, at least one sensor 106 and a memory 110. Processor 102 can be, for example, a microprocessor, a processor core, a multi-core processor, a central processing unit (CPU), a special purpose processor, a digital signal processor, or other types of processor. Sensor(s) 106 can include, for example, image sensors (e.g., cameras), temperature sensors, infrared sensors, microphones, tactile sensors, mechanical sensors, various types of IoT sensors or other types of sensors. Memory 110 can be a memory module including at least one type of memory device, including volatile and/or non-volatile memory devices.

In one embodiment, processor 102 can be configured to operate a transfer learning chip 120. In one embodiment, transfer learning chip 120 can be a part of processor 102. In one embodiment, transfer learning chip 120 can be a single semiconductor package integrated on the same circuit board as processor 102. In one embodiment, transfer learning chip 120 can be a single semiconductor package integrated on a circuit board different from a circuit board integrated with processor 102.

Transfer learning chip 120 can include a non-volatile memory (NVM) 112 and an NVM 114. NVM 112 and NVM 114 can be different types of NVM devices. In one or more embodiments, NVM 112 can be a monolithic three-dimensional (3D) analog NVM, or a multi-level-cell (MLC) NVM, such as a 3D NAND flash memory, a 3D phase-change memory (PCM), a 3D cross point (3D Xpoint) NVM, or a vertical resistive random-access memory (VRRAM). In one or more embodiments, NVM 114 can be an analog NVM with bi-directional device conductance tunability, such as resistive random-access memory (RRAM), conductive bridging random access memory (CBRAM), ferroelectric field-effect transistors (FeFET), ferroelectric tunneling junction, or electro-chemical random-access memory (ECRAM). NVM 112 and NVM 114 can be fabricated on the same semiconductor package to form transfer learning chip 120.

Transfer learning chip 120, when operated by processor 102, can be configured to implement a transfer learning process 108. In an aspect, transfer learning process 108 can use a machine learning model A developed for a source task T_{A} in a source domain as a starting point. machine learning model A can be trained using a dataset D_{A}. A portion of machine learning model A can be retrained (or its weights can be updated) using a new dataset D_{B} to develop a target machine learning model C for a target task T_{B} in a target domain. A portion A′, including a first set of layers, of machine learning model A can remain in the target machine learning model as fixed or frozen layers, where these frozen layers can remain unchanged (e.g., weights remain unchanged). Portions that are not among portion A′, including a second set of layers, of machine learning model A can be replaced by new layers (e.g., layers not among machine learning model A) and/or retrained in target machine learning model C. If machine learning model A has K layers, then layers 1 to M, can be among frozen layers A′, where M<K. In one embodiment, at least one layer among layers M+1 up to K in machine learning model A can be among the unfrozen layers B. The new layers (e.g., layers not among machine learning model A) and retrained layers from machine learning model A can form unfrozen or trainable layers B (e.g., weights can be trained or adjusted). Hence, target machine learning model C can be a deep learning model implementing a neural network that includes layers A′ from machine learning model A and trainable layers B. Layers A′ can be referred to as an inference engine since weights in layers A′ are frozen, and layers B can be referred to as a training engine since weights in layers B are trainable.

To implement transfer learning process 108 using transfer learning chip 120, weights of frozen layers A′ can be mapped to NVM 112 and weights of unfrozen layers B can be mapped to NVM 114. NVM 112 being an analog memory, such as a monolithic three-dimensional (3D) analog NVM, or a multi-level-cell (MLC) NVM can provide an analog inference engine that has sufficient memory capacity to store the relatively large amounts of weights (e.g., more than one hundred million weights) from frozen layers A′. NVM 114 being an analog NVM with bi-directional device conductance tunability can provide a training engine with bi-directional weight-tunability such that unfrozen layers B can be retrained repeatedly using outputs from NVM 114. Thus, NVM 112 and NVM 114 can be a hybrid analog system (e.g., NVM 112 and NVM 114 being different types of analog components) that constitutes at least a portion of a single neural network. Also, NVM 112 and NVM 114 can be a heterogeneous integration of chiplets (e.g., each one of NVM 112 and NVM 114 can be a chiplet) into a single semiconductor package. In one embodiment, weights from at least one frozen layer among layers A′ can be mapped to NVM 114 such that the frozen layers from A′ previously mapped to NVM 112 can be removed from, or bypassed in, NVM 112. The utilization of different analog NVM devices in the same package can enable transfer learning (e.g., re-training) of relatively large models on autonomous, off-grid edge devices, and analog in-memory computing that can be performed by analog NVM devices (e.g., NVM 112, NVM 114) can improve energy efficiency.

Transfer learning chip 120 can receive a dataset 132 and train target machine learning model C using dataset 132. In one embodiment, dataset 132 can include training data and associated labels such as ground truth data. In one embodiment, sensor 106 can send raw data 130 to processor 102, where raw data 130 can be raw sensor data obtained by sensor 106 such as, for example, temperature readings, optical signals, audio signals, analog signals, or other types of raw sensor data. Processor 102 can be configured to convert raw data 130 into dataset 132, where dataset 132 can be in a data format readable by computing or digital devices (e.g., digital signals). Processor 102 can provide dataset 132 to transfer learning chip 120. Referring to transfer learning process 108, dataset 132 can be dataset D_{B}.

Dataset 132 can be inputted to NVM 112. In one embodiment, dataset 132 can include data represented by different voltage levels, such that an input of dataset 132 to NVM 112 can be an application of a plurality of signals (e.g., voltage signals or pulses) to NVM 112. The application of the signals representing dataset 132 can drive analog components in NVM 112 to output new signals representing intermediate data 134. Intermediate data 134 can be a result of MAC operations performed by NVM 112, and intermediate data 134, which can further undergo through an activation function of a neuron and further converted, can be input to a first layer in unfrozen layers B.

Intermediate data 134 can be provided as an input to NVM 114. The input of intermediate data 134 to NVM 114 can be an application of a plurality of signals (e.g., voltage signals or pulses) to NVM 114. The application of the signals representing intermediate data 134 can drive analog components in NVM 114 to output additional signals representing an output 136. For example, in supervised learning, output 136 of NVM 114 can be compared with training labels to compute an error or a difference. NVM 114 can undergo a training phase in which the sets of weights associated with one or more layers (e.g., among unfrozen layers B) of NVM 114 are updated, for example, via backward propagation or backpropagation, until the error converges to meet an accuracy threshold 140. In one embodiment, for example, output 136 can be provided to a comparison chip 138. Comparison chip 138 can be configured to receive output 136 and accuracy threshold 140 as inputs. Accuracy threshold 140 can be a percentage, or a range of values. Comparison chip 138 can be configured to compare output 136 with training labels to obtain the error, and the error can be compared with accuracy threshold 140 to determine whether target machine learning model C achieved a target accuracy. In one embodiment, comparison chip 138 can include at least one comparator configured to compare signals representing output 136 with signals representing training labels, and to compare errors with accuracy threshold 140.

Weights of layers B mapped to NVM 114 can be adjusted, e.g., based on a gradient descent method or another. The adjusted weights can cause NVM 114 to generate new values for output 136. The new values can be used to determine the errors and based on the errors, it can be determined whether the training iteration for training unfrozen layers B in NVM 114 should stop or continue. For example, comparison chip 138 can compare the new values with accuracy threshold 140. The input of dataset 132, weight adjustment, update to output 136, and comparison with accuracy threshold 140, can be repeatedly performed, until a difference between output 136 and accuracy threshold 140 is below a predefined threshold (or until output 136 is within a range of values defined by accuracy threshold 140). If the difference between output 136 and accuracy threshold 140 is greater than the predefined threshold, processor 102 can continue to perform backward propagation to train unfrozen layers B. If the difference between output 136 and accuracy threshold 140 is less than the predefined threshold, processor 102 can suspend or disable the backward propagation to maintain the target accuracy of target machine learning model C.

In response to reaching the target accuracy, the target machine learning model C can be deployed to perform inference on the target task T_{B}. For example, the weights that achieved the target accuracy can be used for performing inference or prediction on new input data received by sensor 106. In one embodiment, the new input data can be converted from new raw sensor data obtained by sensor 106. In one embodiment, frozen layers A′ can remain mapped to NVM 112 and unfrozen layers B can remain mapped to NVM 114, and target machine learning model C can perform inference using NVM 112 and NVM 114. In one embodiment, at least one layer among unfrozen layers B can be copied from NVM 114 to NVM 112, the at least one layer can be removed or bypassed in NVM 114 during inference, and target machine learning model C can perform inference using NVM 112 with the copied layers and uncopied layers (e.g., layers that were not copied) in NVM 114. In one embodiment, all layers among unfrozen layers B can be copied from NVM 114 to NVM 112 and target machine learning model C can perform inference using NVM 112. In an aspect, copying layers from NVM 114 to NVM 112 can be a one-time operation and computation cost of the copying can be amortized with repeated use for inference. NVM 112 can be optimized for inference, therefore energy efficiency may be improved by processing more layers in NVM 112. One can choose one of the above mentioned embodiments to find the optimum balance between the initial cost of copying layers from NVM 114 to NVM 112 and the improvement in energy efficiency for inference depending on the topology of the network and the frequency of model update for the target application.

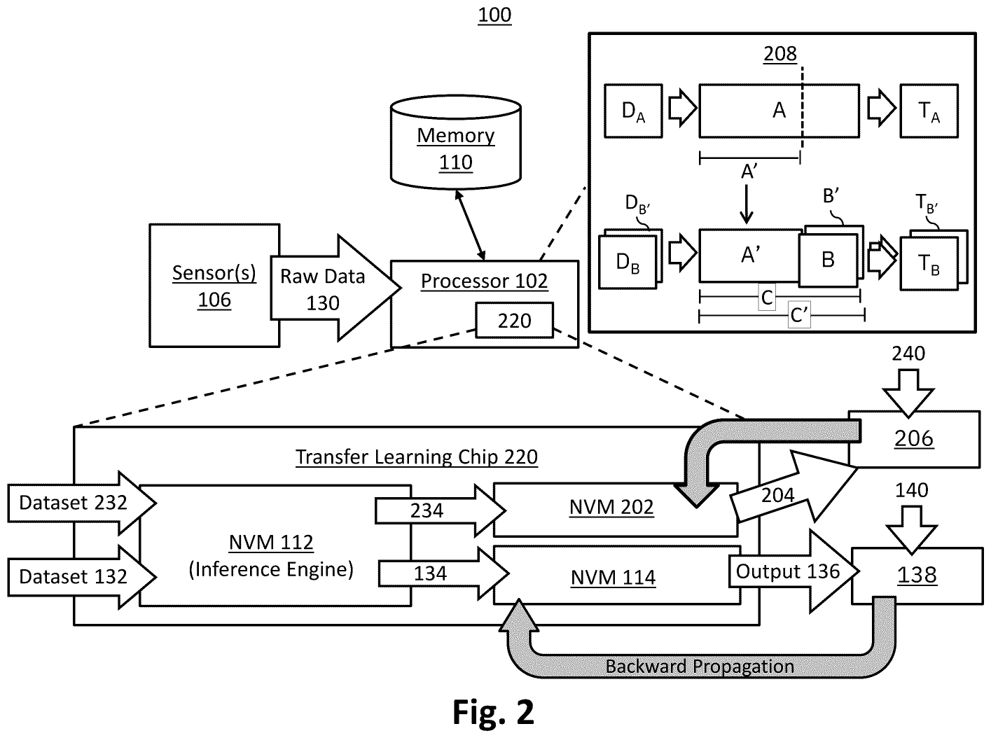

FIG. 2 illustrates an embodiment of the system of FIG. 1 that can implement hybrid analog system for transfer learning. In the embodiment shown in FIG. 2, processor 102 of system 100 can include a transfer learning chip 220. In one embodiment, transfer learning chip 220 can be a single semiconductor package integrated on the same circuit board as processor 102. In one embodiment, transfer learning chip 220 can be a single semiconductor package integrated on a circuit board different from a circuit board integrated with processor 102. Processor 102 can operate transfer learning chip 220 to implement multitask learning.

Transfer learning chip 220 can include NVM 112, NVM 114, and a NVM 202. NVM 114 and NVM 202 can be the same types of NVM device. In one or more embodiments, NVM 202 can be an analog NVM with bi-directional device conductance tunability, such as resistive random-access memory (RRAM), conductive bridging random access memory (CBRAM), ferroelectric field-effect transistors (FeFET), ferroelectric tunneling junction, or electro-chemical random-access memory (ECRAM). NVM 112, NVM 114 and NVM 202 can be fabricated on the same semiconductor package to form transfer learning chip 220. NVM 114 and NVM 202 can be connected in parallel to NVM 112.

Transfer learning chip 220, when operated by processor 102, can be configured to implement a multitask transfer learning process 208. In an aspect, multitask transfer learning process 208 can use machine learning model A developed for source task T_{A} in a source domain as a starting point. Machine learning model A can be trained using a dataset D_{A}. A portion of machine learning model A can be retrained using new datasets D_{B} to develop a target machine learning model, e.g., a new dataset per target machine learning model. For example, a target machine learning model C for a task T_{B} in a target domain can be developed based on dataset D_{B}, and another target machine learning model C′ for a task T_{B′} in another target domain can be developed based on dataset D_{B′}. A portion A′ of machine learning model A can remain in the target machine learning models C, C′ as fixed or frozen layers, where these frozen layers can remain unchanged (e.g., weights remain unchanged). Portions that are not among portion A′ of machine learning model A can be replaced by new layers and/or retrained in target machine learning models C and C′. The new layers and retrained layers from machine learning model A can form unfrozen or trainable layers B and B′ (e.g., weights remain unchanged). Hence, target machine learning model C can be a deep learning model implementing a neural network that includes layers A′ from machine learning model A and trainable layers B. Another target machine learning model, e.g., C′, can be a deep learning model implementing a neural network that includes layers A′ from machine learning model A and trainable layers B′. Layers A′ can be implemented as an inference engine since weights in layers A′ are frozen, and layers B and B′ can be implemented as training engines since weights in layers B and B′ are trainable.

To implement multitask transfer learning process 208 using transfer learning chip 220, weights of frozen layers A′ can be mapped to NVM 112, weights of unfrozen layers B can be mapped to NVM 114, and weights of unfrozen layers B′ can be mapped to NVM 202. NVM 112, NVM 114 and NVM 202 can be a hybrid analog system that constitutes multiple neural networks.

Transfer learning chip 220 can receive multiple datasets, such as dataset 132 and dataset 232, and train target machine learning models C and C′ using dataset 132 and dataset 232, respectively. Dataset 132 can include training data and associated labels such as ground truth data. Processor 102 can be configured to convert raw data 130 into dataset 132 and dataset 232. Processor 102 can provide dataset 132 and dataset 232 to transfer learning chip 220. Dataset 132 and dataset 232 can be inputted to NVM 112. Signals (e.g., voltage signals or pulses) representing dataset 132 can drive analog components in NVM 112 to output new signals representing intermediate data 134. Intermediate data 134 can be provided as inputs to NVM 114. Signals representing intermediate data 134 can drive analog components in NVM 114 to output additional signals representing output 136. Signals (e.g., voltage signals or pulses) representing dataset 232 can drive analog components in NVM 202 to output new signals representing intermediate data 234. Intermediate data 234 can be provided as inputs to NVM 202. Signals representing intermediate data 234 can drive analog components in NVM 202 to output additional signals representing output 204. Intermediate data 234 can be a result of MAC operations performed by NVM 112, and intermediate data 234, which can further undergo through an activation function of a neuron and converted, can be input to a first layer in unfrozen layers B′.

Signals representing intermediate data 134 can drive analog components in NVM 202 to output additional signals representing output 204. Output 204 can be compared with training labels and the error or difference can be computed. NVM 202 can undergo a training phase in which the sets of weights associated with one or more layers (e.g., among unfrozen layers B′) of NVM 202 are updated, for example, via backward propagation or backpropagation, until the error converges, and/or the output 204 meets the accuracy threshold 140. In one embodiment, output 204 can be provided to comparison chip 206. Comparison chip 206 can be configured to receive output 204 and an accuracy threshold 240 as inputs. Comparison chip 206 can be configured to compare output 204 with training labels to obtain an error, and the error can be compared with accuracy threshold 240 to determine whether target machine learning model C′ achieved a target accuracy. In one embodiment, comparison chip 206 can include at least one comparator configured to compare signals representing training labels, and to compare errors with output 204 with signals representing accuracy threshold 140.

Weights of layers B′ mapped to NVM 202 can be adjusted, e.g., based on a gradient descent method or another method. The adjusted weights can cause NVM 202 to generate new values for output 204. The new values can be used to determine the errors and based on the errors, it can be determined whether the training iteration for training layers B′ in NVM 202 should stop or continue. For example, comparison chip 206 can compare the new values with accuracy threshold 140. The weight adjustment, update to output 204, and comparison with accuracy threshold 140, can be repeatedly performed, until a difference between output 204 and accuracy threshold 140 is below a predefined threshold (or until output 204 is within a range of values defined by accuracy threshold 140). If the difference between output 204 and accuracy threshold 140 is greater than the predefined threshold, processor 102 can continue to perform backward propagation to retrain unfrozen layers B′. If the difference between output 204 and accuracy threshold 140 is less than the predefined threshold, processor 102 can suspend or disable the backward propagation to maintain the target accuracy of target machine learning model C′.

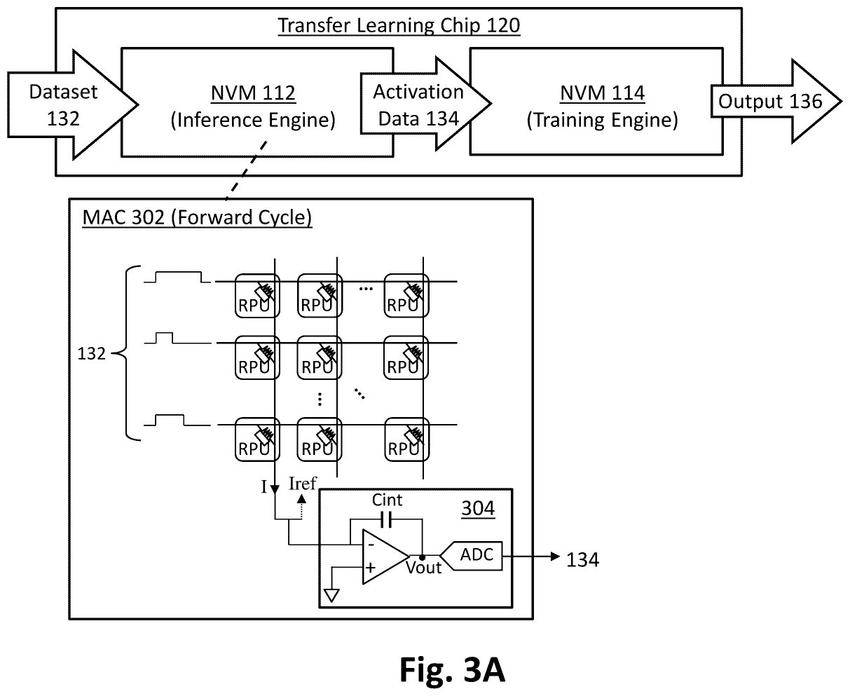

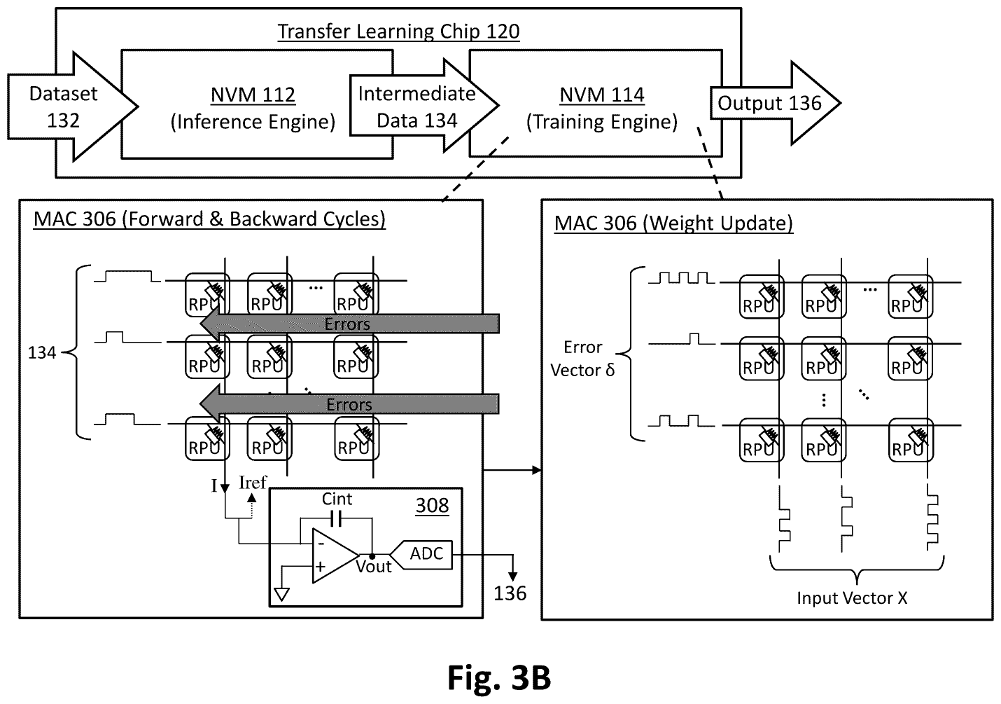

FIG. 3A illustrates details of a first analog component of a hybrid analog system for transfer learning in one embodiment. In an embodiment shown in FIG. 3A, NVM 112 can include a multiply-accumulate unit (MAC) 302. MAC 302 can be implemented by a crossbar array of resistive processing units (RPUs). Each RPU in MAC 302 can store a weight, where the weights stored in RPUs in MAC 302 are used in computing outputs of neurons in a layer of frozen layers A′ (see FIG. 1). The RPUs can be arranged to represent a matrix of weights for a layer among frozen layers A′. MAC 302 can operate in a forward cycle where signals representing dataset 132 can be inputted to the row lines of MAC 302, and a read-out circuit 304 can accumulate current from each column of RPUs to generate signals representing intermediate data 134.

FIG. 3B illustrates details of a training engine of a hybrid analog system for transfer learning in one embodiment. In an embodiment shown in FIG. 3B, NVM 114 can include a multiple\y-accumulate unit (MAC) 306. MAC 306 can be implemented by a crossbar array of resistive processing units (RPUs). Each RPU in MAC 306 can store a weight, where the weights stored in RPUs in MAC 302 are used in computing outputs of neurons in a layer of unfrozen layers B (see FIG. 1). The RPUs can be arranged to represent a matrix of weights for a layer the layers among unfrozen layers B. MAC 306 can operate in a forward cycle where signals representing intermediate data 134 can be inputted to the row lines of MAC 306, and a read-out circuit 308 can accumulate current from each column of RPUs to generate signals representing output 136. MAC 306 can operate in a backward cycle where errors obtained based on output 136 can be propagated backwards. The backpropagation of errors can derive an error vector 8 that represents error at each layer among unfrozen layers B.

MAC 306 can operate in a weight update cycle, where error vector 8 can be inputted at the row lines of MAC 306, and an input vector X can be inputted at the column lines of MAC 306. Input vector X can include stochastic pulses that can be used with signals or pulses of error vector 8 to perform bidirectional resistance tuning. A resistive element (e.g., resistor) in an RPU can receive a pulse from error vector 8 at one terminal (e.g., the terminal of the resistive element connected to a row line) and the RPU can receive a pulse from input vector X at another terminal (e.g., the terminal of the resistive element connected to a column line). The pulses received by the two terminals of the resistive element can cause changes to a parameter, such as a resistance, of the resistive element, and the changes are adjustments to a weight stored in the RPU. The forward cycle, backward cycle, and weight update cycle can be repeatedly performed in MAC 306 until an accuracy of the neural network implemented by NVM 112 and NVM 114 achieves a target accuracy.

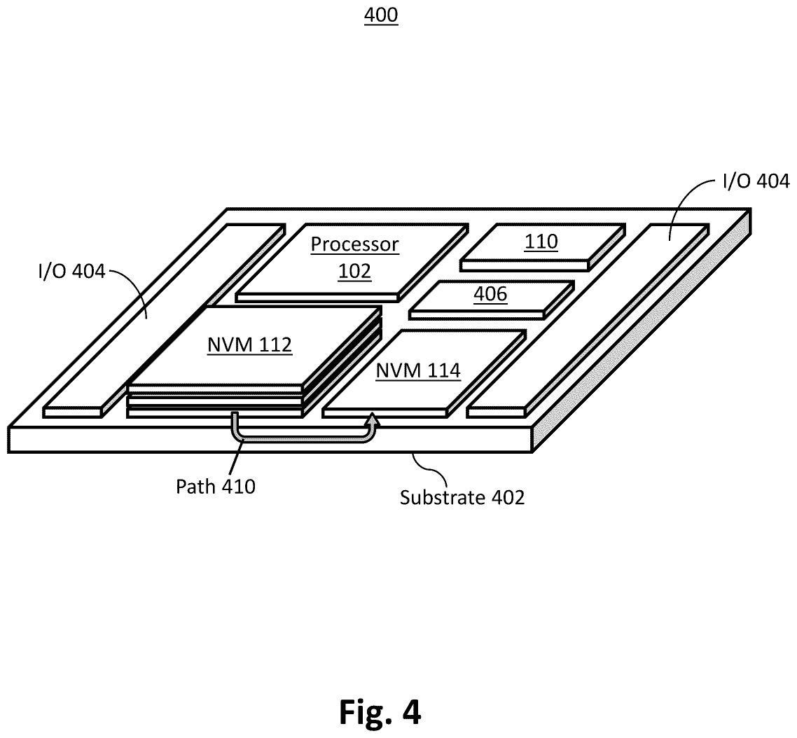

FIG. 4 illustrates an example semiconductor package that can implement hybrid analog system for transfer learning in one embodiment. A semiconductor package 400 is shown in FIG. 4. Processor 102, memory 110, NVM 112 and NVM 114 can be integrated with other heterogeneous components, such as input/output (I/O) circuitry 404 and an accelerator 406, on a substrate 402 to form semiconductor package 400. In one embodiment, substrate 402 can be embedded with components such as conductive traces, vias, pads, contacts, solder bumps, interposers and/or other components that are suitable to be embedded in a substrate of a semiconductor package. In one embodiment, NVM 112 can send signals or data (e.g., intermediate data 134 in FIG. 1) to NVM 114 via conductive paths, such as a path 410, embedded in substrate 402. Using heterogeneous integration techniques to form semiconductor package 400 can achieve relatively high performance at relatively low power consumption.

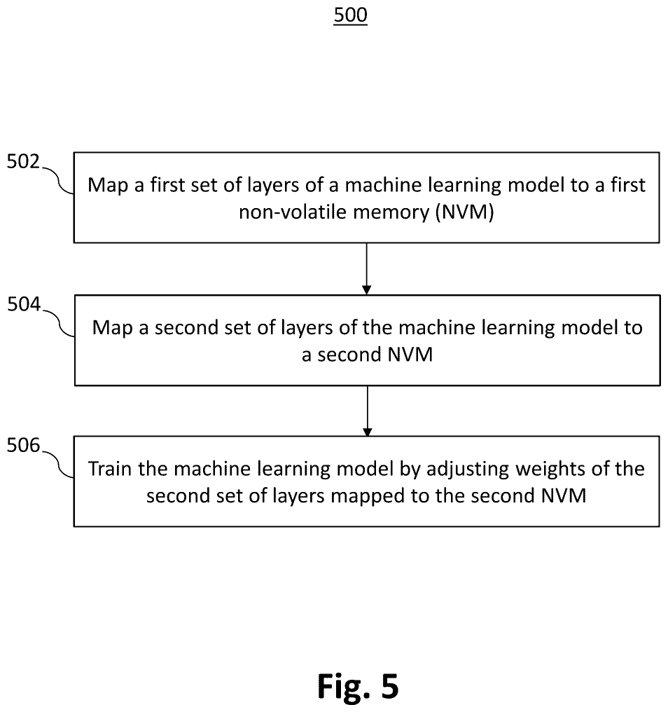

FIG. 5 illustrates a flow diagram relating to hybrid analog system for transfer learning in one embodiment. The process 500 in FIG. 5 may be implemented using, for example, system 100 discussed above. An example process may include one or more operations, actions, or functions as illustrated by one or more of blocks 502, 504, and/or 506. Although illustrated as discrete blocks, various blocks may be divided into additional blocks, combined into fewer blocks, eliminated, performed in different order, or performed in parallel, depending on the desired implementation.

Process 500 can begin at block 502. At block 502, a processor can map a first set of layers of a machine learning model to a first non-volatile memory (NVM). In one embodiment, the first NVM can be one of a monolithic three-dimensional (3D) analog NVM and a multi-level-cell (MLC) NVM. Process 500 can proceed from block 502 to block 504. At block 504, the processor can map a second set of layers of the machine learning model to a second NVM. In one embodiment, the second NVM can be an analog NVM with bi-directional device conductance tunability. In one embodiment, the first NVM and the second NVM can be integrated on a same package. In one embodiment, the second NVM and at least one additional copy of the second NVM can be connected to the first NVM to implement multitask learning.

Process 500 can proceed from block 504 to block 506. At block 506, the processor can train the machine learning model by adjusting weights of the second set of layers mapped to the second NVM. In one embodiment, the first NVM and the second NVM can constitute a neural network. In one embodiment, the processor can copy a portion of the first set of layers from the first NVM to the second NVM and bypass the copied portion in the first NVM in the training of the machine learning model.

In one embodiment, training the machine learning model can include inputting a dataset to the first NVM. The processor can apply the dataset on the first set of layers mapped to the first NVM to generate intermediate data. The processor can further apply the intermediate data on the second set of layers mapped to the second NVM to generate an output. The processor can further adjust, based on the output, weights of the second set of layers mapped to the second NVM. In one embodiment, the processor can repeat the application of the intermediate data and the adjusting until a target accuracy of the machine learning model is achieved.

In one embodiment, in response to achieving the target accuracy, the processor can use the machine learning model to perform inference of new input data. In one embodiment, in response to achieving the target accuracy, the processor can copy a portion of the second set of layers from the second NVM to the first NVM and run the machine learning model using the first NVM with the copied portion and the second NVM to perform inference of new input data. In one embodiment, in response to achieving the target accuracy, the processor can copy the second set of layers from the second NVM to the first NVM and run the machine learning model using the first NVM to perform inference of new input data.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a first non-volatile memory (NVM) configured to store weights of a first set of layers of a machine learning model, wherein weights of the first set of layers are fixed; and
a second NVM configured to store weights of a second set of layers of the machine learning model, wherein weights of the second set of layers are adjustable.

2. The semiconductor device of claim 1, wherein the first NVM is at least one of:
an analog NVM; and
a multi-level-cell (MLC) NVM.

3. The semiconductor device of claim 2, wherein the first NVM is a monolithic three-dimensional (3D) NVM.

4. The semiconductor device of claim 1, wherein at least one of the NVMs is configured to perform compute-in-memory.

5. The semiconductor device of claim 1, wherein the second NVM is an analog NVM with bi-directional device conductance tunability.

6. The semiconductor device of claim 1, wherein the first NVM and the second NVM constitute at least a portion of a neural network.

7. The semiconductor device of claim 1, wherein the first NVM and the second NVM are integrated on a same package.

8. The semiconductor device of claim 1, wherein the second NVM and at least one additional copy of the second NVM are connected to the first NVM to implement multitask learning.

9. A method comprising:
mapping a first set of layers of a machine learning model to a first non-volatile memory (NVM);
mapping a second set of layers of the machine learning model to a second NVM; and
training the machine learning model by adjusting weights of the second set of layers mapped to the second NVM.

10. The method of claim 9, further comprising:
copying a portion of the first set of layers from the first NVM to the second NVM; and
bypassing the copied portion in the first NVM in the training of the machine learning model.

11. The method of claim 9, wherein the training of the machine learning model comprises:
inputting a dataset to the first NVM;
applying the dataset on the first set of layers mapped to the first NVM to generate intermediate data;
applying the intermediate data on the second set of layers mapped to the second NVM to generate an output; and
adjusting, based on the output, the weights of the second set of layers mapped to the second NVM.

12. The method of claim 11, wherein the method further comprises:
repeating the application of the intermediate data and the adjustment of weights until a target accuracy of the machine learning model is achieved; and
in response to achieving the target accuracy, using the machine learning model to perform inference of new input data.

13. The method of claim 12, wherein in response to achieving the target accuracy, the method further comprises:
copying a portion of the second set of layers from the second NVM to the first NVM; and
running the machine learning model using the first NVM with the copied portion and uncopied portions of the second set of layers in the second NVM to perform inference of new input data.

14. The method of claim 12, wherein in response to achieving the target accuracy, the method further comprises:
copying the second set of layers from the second NVM to the first NVM; and
running the machine learning model using the first NVM to perform inference of new input data.

15. A device comprising:
a sensor configured to obtain raw sensor data;
a chip including a first non-volatile memory (NVM) and a second NVM; and
a processor configured to:
convert the raw sensor data into a dataset;
input the dataset to the NVM, wherein a first set of layers of a machine learning model is mapped to the first NVM;
apply the dataset on the first set of layers mapped to the first NVM to generate intermediate data;
apply the intermediate data on a second set of layers mapped to the second NVM to generate an output; and
adjust, based on the output, weights of the second set of layers mapped to the second NVM to train the machine learning model.

16. The device of claim 15, wherein the first NVM is at least one of:
an analog NVM; and
a multi-level-cell (MLC) NVM.

17. The device of claim 15, wherein the second NVM is an analog NVM with bi-directional device conductance tunability.

18. The device of claim 15, wherein the first NVM and the second NVM constitute at least a portion of a neural network.

19. The device of claim 15, wherein the first NVM and the second NVM are integrated on a same package.

20. The device of claim 15, wherein the processor is configured to:
repeat the application of the intermediate data and the adjustment of weights until a target accuracy of the machine learning model is achieved; and
use the machine learning model to perform inference of new input data.
